(19) United States
(12) Patent Application Publication
(10) Pub. No.: US 2019/0203019 A1
(43) Pub. Date: Jul. 4, 2019

(54) METHOD OF MANUFACTURING ENVIRONMENT-FRIENDLY SYNTHETIC BOARD INCLUDING COFFEE SLUDGE

(71) Applicants: Sang Duk LEE, Siheung-si (KR); Yong Chun LEE, Siheung-si (KR)

(72) Inventor: Sang Duk LEE, Siheung-si (KR)

(21) Appl. No.: 16/172,340

(22) Filed: Oct. 26, 2018

(30) Foreign Application Priority Data
Dec. 28, 2017 (KR) 10-2017-0183011

(51) Int. Cl. C08K 13/08; B29C 47/00; C08J 3/18; C08J 3/20

(52) U.S. Cl. CPC C08K 13/08; B29C 47/0066; B29C 47/0004; B29L 2031/732; C08J 3/18; C08J 3/203; B29C 47/0019

(57) ABSTRACT

Disclosed herein are a composition for an environment-friendly synthetic board including coffee sludge, which is used to manufacture an environment-friendly synthetic board, such as flooring, a molded synthetic board for architecture, or the like, by using coffee sludge that is left as residual waste after the sale of coffee in a specialty coffee shop, or the like, and a method of manufacturing an environment-friendly synthetic board by using the composition. The composition is formed by adding, per 100 parts by weight of coffee sludge powder, 12.5 to 15 parts by weight of synthetic resin, 4 to 8 parts by weight of calcium carbonate, 15 to 20 parts by weight of talc, and 1 to 4 parts by weight of plasticizer, and then mixing them.

### CROSS-REFERENCE TO RELATED APPLICATION

This application claims the benefit of Korean Patent Application No. 10-2017-0183011 filed on Dec. 28, 2017, which is hereby incorporated by reference herein in its entirety.

### BACKGROUND

### 1. Technical Field

The present invention relates to a method of manufacturing an environment-friendly synthetic board including coffee sludge, which is capable of manufacturing an environment-friendly synthetic board, such as flooring, a molded synthetic board for architecture, or the like, by using coffee sludge that is left as residual waste after the sale of coffee in specialty coffee shops, or the like.

### 2. Description of the Related Art

With a change in preference attributable to a recent living environment, the demand for coffee in Korea has rapidly increased.

Conventionally, most of the coffee has been distributed in the form of instant coffee mixes or coffee beans, and has been used as raw material for extracting coffee at small scales in teahouses or retail stores or has been used for making coffee in the homes of common consumers.

Therefore, coffee sludge has been also mixed and disposed of in the waste of teahouses or homes. In recent years, however, the demand for coffee has increased dramatically, and the rate of consumption of coffee has increased significantly due to the development of canned coffee, coffee vending machines, instant coffee, and coffee franchising industries. Accordingly, coffee sludge is generated in large quantities in factories that produce instant coffee and the like.

The coffee sludge generated as described above is treated as waste and processed by a method, such as landfill or incineration. As the amount of coffee sludge generated increases and interest in environmental pollution increases, a problem arises in that it is difficult to treat coffee sludge by using the conventional methods.

For this reason, in recent years, research has been conducted on the use of coffee sludge as nutrients for flowerpots or the like, or as odor removers. However, there has been no research on the effective application of coffee sludge itself. Therefore, the effective use of coffee sludge is a very important issue from the viewpoint of environmental protection.

### PRIOR ART DOCUMENTS

### Patent Documents

(patent document 1) Korean Patent No. 10-1653285 (patent document 2) Korean Patent No. 10-1733306 (patent document 3) Korean Patent No. 10-1645205

### SUMMARY

An object of the present invention is to provide a method of manufacturing a synthetic board including coffee sludge, which is capable of manufacturing an environment-friendly synthetic board, such as flooring, a molded synthetic board for architecture, or the like, including coffee sludge, generated in coffee processing factories, coffee shops, or the like, as an important effective component.

In order to accomplish the above object, the present invention provides a composition that is formed by adding, per 100 parts by weight of coffee sludge powder, 12.5 to 15 parts by weight of synthetic resin, 4 to 8 parts by weight of calcium carbonate, 15 to 20 parts by weight of talc, and 1 to 4 parts by weight of plasticizer, and then mixing them.

The coffee sludge powder may have a moisture content of to 20% and a particle-size distribution of 50 to 200 meshes.

The synthetic resin may be any one selected from the group consisting of synthetic rubber, PVC, TPU, and TPE.

3 to 5 parts by weight of waste synthetic fiber having a length of 30 to 50 mm may be further added to the composition, per 100 parts by weight of coffee sludge powder.

0.1 to 0.5 part by weight of at least one far-infrared ray radiation material selected from the group consisting of powdery red clay, pearlite, elvan, jade powder, sulfur, and germanium ore powder, each having a particle-size distribution of 50 to 200 meshes, may be further added to the composition, per 100 parts by weight of coffee sludge powder.

In order to accomplish the above object, the present invention provides a method of manufacturing an environment-friendly synthetic board, the method including:

(A) preparing coffee sludge by collecting the coffee sludge and drying the collected coffee sludge to a moisture content of 30% or less;

(B) adding calcium carbonate to the coffee sludge, uniformly mixing the calcium carbonate and the coffee sludge to form a mixture, drying the mixture to a moisture content of 20% or less at room temperature, and grinding the dried mixture to a particle-size distribution of 50 to 200 meshes;

(C) after completion of step (B), forming a composition for a synthetic board by adding synthetic resin, a dispersant, and a plasticizer to the mixture, and uniformly mixing and melting the resulting mixture to which the synthetic resin, the dispersant, and the plasticizer have been added;

(D) introducing the composition for a composite board into a metal mold, and extruding the composition for a composite board at a temperature of 165 to 180° C. and a molding pressure of 4 to 4.3 MPa to form a mold; and

(E) cooling the mold formed at step (D), and then cutting the mold to a predetermined size.

The composition of step (C) may be formed by adding, per 100 parts by weight of coffee sludge powder, 12.5 to 15 parts by weight of synthetic resin, 4 to 8 parts by weight of calcium carbonate, 15 to 20 parts by weight of talc, and 1 to 4 parts by weight of plasticizer, and then mixing them.

0.1 to 0.5 part by weight of at least one far-infrared ray radiation material selected from the group consisting of powdery red clay, pearlite, elvan, jade powder, sulfur, and germanium ore powder, each having a particle-size distribution of 50 to 200 meshes, may be further added to the composition of step (C), per 100 parts by weight of coffee sludge powder.

The synthetic resin of step (C) may be any one selected from the group consisting of synthetic rubber, PVC, TPU, and TPE.

3 to 5 parts by weight of waste synthetic fiber having a length of 30 to 50 mm may be further added to the composition of step (C), per 100 parts by weight of coffee sludge powder.

### DETAILED DESCRIPTION

The present invention will be described in greater detail below.

The present invention is intended to provide a method of manufacturing an environment-friendly synthetic board including coffee sludge, which is capable of manufacturing an environment-friendly synthetic board, such as flooring, a molded synthetic board for architecture, or the like, by using coffee sludge that is left as residual waste as the sale of coffee in specialty coffee shops, or the like.

A composition for an environment-friendly synthetic board including coffee sludge according to the present invention is preferably formed by adding, per 100 parts by weight of coffee sludge powder, 12.5 to 15 parts by weight of synthetic resin, 4 to 8 parts by weight of calcium carbonate, 15 to 20 parts by weight of talc, and 1 to 4 parts by weight of plasticizer, and then mixing them.

According to the present invention, in order to ensure high workability and the excellent physical properties of a synthetic board, i.e., a final product, it is preferable to use coffee sludge powder having a moisture content of 15 to 20% and a particle-size distribution of 50 to 200 meshes. In order to meet these conditions, coffee sludge powder suitable for the purpose of the present invention may be prepared and used by performing the process of drying and grinding collected coffee sludge.

In this case, when the moisture content is lower than 15% or higher than 20%, problems may arise in that workability is degraded or an agglomeration phenomenon occurs during the mixing of the composition. Furthermore, in the case where the particle size deviates from the threshold value range, when the particle size is excessively small, a problem may arise in that coupling with synthetic resin is not desirably performed during mixing due to an agglomeration phenomenon or the like and thus moldability is degraded. In contrast, when the particle size is excessively large, a problem may arise in that the physical strength of the board, i.e., a final product, is degraded.

According to the present invention, the synthetic resin used in the present invention is a polymer compound having the property of enabling coffee sludge to adhere together at room temperature or high temperature. Any of thermosetting resin, thermoplastic resin, synthetic rubber, etc. may be used as the synthetic resin as long as it serves as an adhesive for enabling coffee sludge to adhere together when extrusion molding is performed at room temperature or high temperature. Preferably, any one selected from the group consisting of powdery synthetic rubber, PVC, TPU, and TPE processed to have a predetermined particle size is used as the synthetic resin. More preferably, powdery PVC is used as the synthetic resin. The reason for this is that the powdery PVC has the advantages of excellent waterproofness, excellent moisture resistance, excellent durability, no expansion, contraction and distortion attributable to moisture, no need for antiseptic and chemical processing, dimensional stability, and excellent workability.

Preferably, 12.5 to 15 parts by weight of synthetic resin is preferably mixed per 100 parts by weight of coffee sludge powder. When the quantity of synthetic resin mixed is lower than 12.5 parts by weight, a problem arises in that a final board is broken due to a poor adhesive property. In contrast, when the quantity of synthetic resin mixed is larger than 15 parts by weight, a problem arises in that workability is poor because strength is higher than a reference value.

According to the present invention, the calcium carbonate constituting part of the composition reacts with moisture contained in the coffee sludge to thus generate calcium hydroxide, and generates carbon dioxide to thus reduce the content of moisture contained in the coffee sludge, thereby functioning to increase moldability. When the quantity of calcium carbonate mixed is smaller than 4 parts by weight, a disadvantage arises in that the surface of a board has depressions like basalt. In contrast, the quantity of calcium carbonate mixed is larger than 8 parts by weight, a disadvantage arises in that non-uniform density is generated because a bubble layer is formed on an internal cut layer during cutting.

According to the present invention, a dispersant is used to improve the dispersibility of the composition. Any dispersant may be used as long as it can be used to manufacture the synthetic board. In order to secure environmental friendliness, which is one of the purposes of the present invention, and in order to acquire a uniform mixture of the melt of the synthetic resin and the coffee sludge during molding, an alkaline dispersant is preferably used.

According to the present invention, the plasticizer is an organic material that facilitates a molding process at high temperature by increasing the thermoplasticity of synthetic resin. Preferably, DOTP, which is an environment-friendly plasticizer, is used as the plasticizer. In this case, when the quantity of plasticizer mixed is smaller than 1 part by weight, problems arise in that the hardness of a board is poor and a deflection occurs. In contrast, when the quantity of plasticizer mixed is larger than 5 parts by weight, physical properties (hardness and strength) are excellent, but a problem arises in that the wear of a tool increases during processing.

According to the present invention, in order to improve the moldability and physical properties of a synthetic board manufactured using the composition, 3 to 5 parts by weight of waste synthetic fiber having a length of 30 to 50 mm may be further added per 100 parts by weight of coffee sludge powder. In this case, the waste synthetic fiber is obtained by processing polymer resin. When the waste synthetic resin is molded by applying a predetermined temperature, the waste synthetic resin is melted and serves as an adhesive, and also it is uniformly distributed and produces the effect of increasing the physical strength of a synthetic board. When the quantity of waste synthetic fiber mixed is smaller than 3 parts by weight, a disadvantage arises in that the improvement of physical strength expected by the mixing of waste fiber cannot be achieved. In contrast, when the quantity of waste synthetic fiber mixed is larger than 5 parts by weight and a quantity of waste fiber larger than a required quantity is mixed and melted, there may occur a phenomenon in which coffee sludge powder is agglomerated by the waste fiber, and thus the physical strength of a specific portion may be degraded. Accordingly, a problem may arise in that product defect rate increases.

According to the present invention, 0.1 to 0.5 part by weight of at least one far-infrared ray radiation material selected from the group consisting of powdery red clay, pearlite, elvan, jade powder, sulfur, and germanium ore powder, each having a particle-size distribution of 50 to 200 meshes, may be further added per 100 parts by weight of coffee sludge powder. In this case, when the particle size of the far-infrared ray radiation material deviates from the threshold value range, i.e., when the particle size is excessively large, a disadvantage arises in that the roughness of the surfaces of a synthetic board, i.e., a final finished product, is significantly poor. In contrast, when the particle size is excessively small, a problem arises in that the miscibility of a mixture decreases before the molding of a mold. Accordingly, a problem may arise in that the physical strength of a synthetic board decreases due to a reduction in moldability, or a minute crack occurs in a synthetic board, i.e., a final finished product, after molding.

Meanwhile, when the quantity of far-infrared ray radiation material added is smaller than 0.1 parts by weight, a disadvantage arises in that the purpose of addition is not met because a far-infrared ray radiation effect is insignificant. In contrast, when the quantity of far-infrared ray radiation material added is larger than 0.5 parts by weight, a far-infrared ray radiation effect can increase, but disadvantages arise in that manufacturing cost increases and coupling with synthetic resin is poor.

The present invention may provide a method of manufacturing an environment-friendly synthetic board by using the above-described composition according to the present invention.

In greater detail, the method of manufacturing an environment-friendly synthetic board according to the present invention may be configured to include the following steps:

(A) preparing coffee sludge by collecting the coffee sludge and drying the collected coffee sludge to a moisture content of 30% or less;

(B) adding calcium carbonate to the coffee sludge, uniformly mixing the calcium carbonate and the coffee sludge to form a mixture, drying the mixture to a moisture content of 20% or less at room temperature, and grinding the dried mixture to a particle-size distribution of 50 to 200 meshes;

(C) after the completion of step (B), forming a composition for a synthetic board by adding synthetic resin, a dispersant, and a plasticizer to the mixture, and uniformly mixing and melting the resulting mixture to which the synthetic resin, the dispersant, and the plasticizer have been added;

(D) introducing the composition for a composite board into a metal mold, and extruding the composition for a composite board at a temperature of 165 to 180° C. and a molding pressure of 4 to 4.3 MPa to form a mold; and

(E) cooling the mold formed at step (D), and then cutting the mold to a predetermined size.

According to the present invention, the coffee sludge processed at step (B) may be preferably dried to a moisture content of 15 to 20%.

According to the present invention, the composition of step (C) may be formed by adding, per 100 parts by weight of coffee sludge powder, 12.5 to 15 parts by weight of synthetic resin, 4 to 8 parts by weight of calcium carbonate, 15 to 20 parts by weight of talc, and 1 to 4 parts by weight of plasticizer and then mixing them.

According to the present invention, 0.1 to 0.5 part by weight of at least one far-infrared ray radiation material selected from the group consisting of powdery red clay, pearlite, elvan, jade powder, sulfur, and germanium ore powder, each having a particle-size distribution of 50 to 200 meshes, may be further added to the composition of step (C), per 100 parts by weight of coffee sludge powder.

According to the present invention, any one selected from the group consisting of synthetic rubber, PVC, TPU, and TPE may be used as the synthetic resin of step (C).

According to the present invention, 3 to 5 parts by weight of waste synthetic fiber having a length of 30 to 50 mm may be further added to the composition of step (C), per 100 parts by weight of coffee sludge powder.

The present invention will be described in detail in conjunction with preferred examples. However, the following examples are only illustrative of the present invention, and thus the present invention is not limited to the following examples. It will be apparent to those skilled in the art that modifications and alterations may be made without departing from the scope of the present invention set forth in the attached claims.

### Examples 1 to 4

<Preparation of Materials>

1. Coffee Sludge Powder

Coffee sludge was collected in an instant coffee processing factory, the collected coffee sludge was fully dried to a moisture content of 30% or less in a drying machine, calcium carbonate was added to the dried coffee sludge, the calcium carbonate and the coffee sludge were uniformly mixed to thus form a mixture, and the mixture was naturally dried to a moisture content of 20% or less in a drying room maintained at a temperature of 25 to 35° C. Coffee sludge powder was prepared by grinding the dried coffee sludge to a particle-size distribution of 50 to 200 meshes. 2. Synthetic resin: PVC SG5 having physical properties set forth in table 1 below:

TABLE 1

| Index/Tech Data | | | SG5 |
|---|---|---|---|
| Viscosity ml/g | | | 118-107 |
| (or k value) Average Degree of Polymerization | | | (68-66) |
| | | | 1100-1000 |
| Impurity, Piece ≤s | | | 30 |
| Volatile (including water) Content %≤ | | | 0.40 |
| Apparent Density g/ml≥ | | | 0.42 |
| Sieve Residue % | Sieve Rate % | 0.25 mm Sieve Pore≤ | 2.0 |
| | Sieve Rate % | 0.063 mm Sieve Pore≥ | 90 |

| | |
|---|---|
| “Pearl eye” number, Piece/400 cm²≤ | 40 |

| | |
|---|---|
| 100 g resin plasticizer absorption capacity g. | 19 |
| Whiteness (160° C., 100 min), %≥ | 74 |
| Water liquid extract conductance ratio s/m< | — |
| Remain chloroethylene Content μg/g< | 5 |

3. Calcium carbonate: (anhydrous) calcium carbonate manufactured by Daemyung Chemical Co., Ltd.

4. Talc: talc powder manufactured by Daemyung Chemical Co., Ltd.

5. Plasticizer: SP-390 manufactured by Hanwha Chemical Co., Ltd.

6. Far-infrared ray radiation material: red clay and elvan powder having a particle-size distribution of 50 to 200 meshes

7. Waste synthetic fiber: PET fiber prepared by cutting PET fiber to a length of 30 to 50 mm

A composition formed by mixing the prepared materials at the composition ratio listed in table 2 was melted while being stirred in a melting machine at a temperature of 100 to 120° C. for 10 to 20 minutes to form a melt, the melt was introduced into a metal mold and extruded at a temperature of 165 to 180° C. and a molding pressure of 4 to 4.3 MPa to form a mold, and the mold was cooled and cut into synthetic board specimens each having a size of length*width*height=500 mm*500 mm*18 mm.

TABLE 2

| | Embodiment | Embodiment | Embodiment | Embodiment |
|---|---|---|---|---|
| Material | 1 | 2 | 3 | 4 |
| Coffee sludge | 100 | 100 | 100 | 100 |
| powder | | | | |
| Synthetic resin | 12.5 | 13 | 14 | 15 |
| Calcium | 4 | 5 | 7 | 8 |
| carbonate | | | | |
| Talc | 15 | 16 | 18 | 20 |
| Plasticizer | 1 | 2 | 3 | 4 |
| Red clay | — | 0.2 | 0.2 | 0.1 |
| Elvan | — | — | 0.2 | 0.4 |
| Waste synthetic | — | — | — | 4 |
| fiber | | | | |

The mixing ratio listed in Table 2 is parts by weight. The unit of the mixing ratio in table 2 is parts by weight.

The physical properties of the specimens prepared in examples 1 to 4 as listed in table 2 were measured by a standard test method, and the results of the tests are listed in table 3 below.

### Comparative Example

A conventional synthetic board (wood/a medium density fiberboard 18T) of Kwangwon Lumber Co., Ltd. having no coffee sludge unlike in the above examples was prepared, the physical properties of the prepared composite board were measured by the standard test method, and the results of the tests are listed in table 3 below.

TABLE 3

| | Example | Example | Example | Example | Comparative |
|---|---|---|---|---|---|
| Item | 1 | 2 | 3 | 4 | example |
| Density | 0.65 | 0.63 | 0.62 | 0.66 | 0.7 |
| Tensile | 249 | 238 | 242 | 258 | 270 |
| strength | | | | | |
| (kgf/cm²) | | | | | |
| Flexural | 436 | 417 | 423 | 442 | 450 |
| strength | | | | | |
| (kgf/cm²) | | | | | |
| Aesthetics | 5 | 4 | 4 | 5 | 3 |

In table 3 above, the aesthetics were evaluated by the responses of 50 subjects. The scores and the evaluation criteria were based on a 5-point scoring method (5: very good, 4: good, 3: moderate, 2: poor, and 1: very poor).

As can be seen from the results of table 3 above, it was found that the synthetic board formed using the coffee sludge according to the present invention can ensure physical properties that were not significantly inferior to those of the conventional synthetic board. As a result, it was also found that it could be used sufficiently for the purposes of flooring, building boards, etc.

Furthermore, as a result of the evaluation of the aesthetics by the subjects, i.e., a type of sensory evaluation, it was found that the synthetic board according to the present invention was considerably superior to the conventional synthetic board.

The composition for an environment-friendly synthetic board including coffee sludge and the method of manufacturing an environment-friendly synthetic board by using the composition provide the advantage of providing a building material having air freshening, moisture-proof and deodorizing effects based on the intrinsic properties of the coffee sludge by recycling the coffee sludge, which is one of the natural resources that are disposed of as waste.

Furthermore, the synthetic board is manufactured by recycling the coffee sludge that has been discarded as waste, and thus a material that may cause environmental pollution or that may be harmful to human bodies can be minimized, thereby enabling a waste resource to be more efficiently recycled.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A method of manufacturing an environment-friendly synthetic board, the method comprising:
(A) preparing coffee sludge by collecting the coffee sludge and drying the collected coffee sludge to a moisture content of 30% or less;
(B) adding calcium carbonate to the coffee sludge, uniformly mixing the calcium carbonate and the coffee sludge to form a mixture, drying the mixture to a moisture content of 20% or less at room temperature, and grinding the dried mixture to a particle-size distribution of 50 to 200 meshes;
(C) after completion of step (B), forming a composition for a synthetic board by adding synthetic resin, a dispersant, and a plasticizer to the mixture, and uniformly mixing and melting the resulting mixture to which the synthetic resin, the dispersant, and the plasticizer have been added;
(D) introducing the composition for a composite board into a metal mold, and extruding the composition for a composite board at a temperature of 165 to 180° C. and a molding pressure of 4 to 4.3 MPa to form a mold; and
(E) cooling the mold formed at step (D), and then cutting the mold to a predetermined size.

2. The method of claim 1, wherein the composition of step (C) is formed by adding, per 100 parts by weight of coffee sludge powder, 12.5 to 15 parts by weight of synthetic resin, 4 to 8 parts by weight of calcium carbonate, 15 to 20 parts by weight of talc, and 1 to 4 parts by weight of plasticizer, and then mixing them.

3. The method of claim 1, wherein 0.1 to 0.5 part by weight of at least one far-infrared ray radiation material selected from the group consisting of powdery red clay, pearlite, elvan, jade powder, sulfur, and germanium ore powder, each having a particle-size distribution of 50 to 200 meshes, is further added to the composition of step (C), per 100 parts by weight of coffee sludge powder.

4. The method of claim 1, wherein the synthetic resin of step (C) is any one selected from the group consisting of synthetic rubber, PVC, TPU, and TPE.

5. The method of claim 1, wherein 3 to 5 parts by weight of waste synthetic fiber having a length of 30 to 50 mm is further added to the composition of step (C), per 100 parts by weight of coffee sludge powder.
